(19) United States
(12) Patent Application Publication
(10) Pub. No.: US 2026/0106772 A1
(43) Pub. Date: Apr. 16, 2026

(54) APPARATUS AND METHOD FOR PROVIDING ONLINE MEETING SERVICE CONSIDERING IN-VEHICLE ENVIRONMENT

(71) Applicants: HYUNDAI MOTOR COMPANY, Seoul (KR); KIA CORPORATION, Seoul (KR)

(72) Inventor: Joon Hyung Kim, Hwaseong-si (KR)

(73) Assignees: HYUNDAI MOTOR COMPANY, Seoul (KR); KIA CORPORATION, Seoul (KR)

(21) Appl. No.: 19/198,880

(22) Filed: May 5, 2025

(30) Foreign Application Priority Data
Oct. 14, 2024 (KR) 10-2024-0139750

(51) Int. Cl. H04L 12/18; G01C 21/34

(52) U.S. Cl. CPC H04L 12/1822; G01C 21/34

(57) ABSTRACT

A method of providing an online meeting service considering an in-vehicle environment includes accessing an online meeting through a vehicle terminal. The method also includes determining a possible interaction level of a driver of the vehicle during the online meeting, based on operating status of the vehicle, while participating in the online meeting. The method additionally includes configuring participation status in the online meeting depending on the determined possible interaction level.

### CROSS-REFERENCE TO RELATED APPLICATION(S)

The present application claims the benefit of and priority to Korean Patent Application No. 10-2024-0139750, filed on Oct. 14, 2024, the entire contents of which are hereby incorporated herein by reference.

### BACKGROUND

### 1. Technical Field

The present disclosure relates to an apparatus and a method for providing an online meeting service that provides various functions in consideration of an in-vehicle environment. 2. Description of the Related Art

Recently, online meetings, which are relatively free from time and place constraints, have become common. In general, online meetings are conducted by respective participants executing a dedicated application or web browser on a terminal that supports data communication functions and accessing a service platform therethrough.

With the improvement in performance of terminals installed in recent vehicles, improvement in communication performance, and development of autonomous driving functions, providing a function of accessing the online meeting platform from the vehicle terminals may be possible.

In general, participants using online meetings are required to constantly interact with other users, except in some situations such as simply listening to other users'speeches or lectures. This interaction varies in level depending on the situation such as seeing and listening to other users'speeches, watching shared content, or a direct speech of the participant. However, when accessing the online meeting platform through a vehicle terminal, drivers in particular are subject to significant restrictions on the interaction level depending on the driving situation. For example, the driver is able to have most free interactions when the vehicle is parked or stopped, and relatively free interactions when autonomous driving is in progress, depending on the autonomous driving level, but the interactions may be greatly restricted for safety reasons while driving. In addition, the driver may have a limited level of interaction in the case of conversations with other passengers or operating vehicle functions other than driving, in addition to the driving situation.

The foregoing description in this Background section is intended merely to aid in the understanding of the general background of the present disclosure, and is not intended to mean that the present disclosure falls within the purview of the related art already known to those having ordinary skill in the art.

### SUMMARY

Various aspects of the present disclosure provide an apparatus and a method for providing an online meeting service that provides various functions considering the in-vehicle environment.

Embodiments of the present disclosure provide various functions considering operating situation of a vehicle or a situation of a driver when the driver participates in an online meeting service in the vehicle.

The technical objects of the present disclosure are not limited to the technical objects mentioned above. Other technical objects not mentioned herein should be more clearly understood by those having ordinary skill in the art to which the present disclosure pertains from the following description.

According to an embodiment of the present disclosure, a method of providing an online meeting service considering an in-vehicle environment is provided. The method includes accessing an online meeting through a terminal of a vehicle. The method also includes determining a possible interaction level of a driver of the vehicle during the online meeting, based on operating status of the vehicle, while participating in the online meeting. The method additionally includes configuring participation status in the online meeting depending on the possible interaction level.

In an embodiment, the method may further include transmitting information about the determined possible interaction level to an online meeting platform server so that the information is shared with other users participating in the online meeting.

In an embodiment, the participation status may include a plurality of states having different possible interaction levels and proposing functions.

In an embodiment, the method may further include restricting at least one of functions of transmitting or receiving at least one or video or audio depending on the determined possible interaction level.

In an embodiment, the method may further include determining a route to a destination, and determining whether or not a driving caution section exists on the determined route. Configuring participation status may further include, if the driving caution section exists and as the vehicle enters the driving caution section, adjusting the participation status to a state corresponding to entry into the driving caution section.

In an embodiment, the method may further include, in response to determined that the driving caution section exists and a predetermined condition is satisfied before the vehicle enters the driving caution section, outputting progress information including at least one of a remaining time or a distance until the vehicle enters the driving caution section.

In an embodiment, the method may further include transmitting summary information about the determined route to an online meeting platform server so that the information is shared with other users participating in the online meeting.

In an embodiment, determining the route may include, upon determining that information about a start time of the online meeting exists, determining a route passing through a place where parking or stopping is possible or a road that supports a certain level or higher of semi-autonomous driving function at the start time.

In an embodiment, the operating status of the vehicle may include at least one of information about whether the vehicle is parked or stopped or information about whether a driver assistance function is activated or intervenes.

In another embodiment, an apparatus for providing an online meeting service for a vehicle is provided. The apparatus includes an input/output device and an online meeting control device configured to provide a user interface through the input/output device when accessing an online meeting. The apparatus also includes a situation analysis device configured to determine a possible interaction level of a driver of the vehicle during the online meeting, based on operating status of the vehicle, while participating in the online meeting. The online meeting control device is configured to configure participation status in the online meeting depending on the possible interaction level.

In an embodiment, the online meeting control device may be configured to transmit information about the determined possible interaction level to an online meeting platform server so that the information is shared with other users participating in the online meeting.

In an embodiment, the participation status may include a plurality of states having different possible interaction levels and proposing functions.

In an embodiment, the online meeting control device may be configured to restrict at least one of functions of transmitting or receiving at least one of video or audio depending on the determined possible interaction level.

In an embodiment, the apparatus may further include a navigation device configured to determine a route to a destination and determine whether or not a driving caution section exists on the determined route. The online meeting control device may be configured to adjust, when the driving caution section exists and as the vehicle enters the driving caution section, the participation status to a state corresponding to entry into the driving caution section.

In an embodiment, the online meeting control device may be configured to, when the driving caution section exists and a predetermined condition is satisfied before the vehicle enters the driving caution section, output progress information including at least one of a remaining time or a distance until the vehicle enters the driving caution section.

In an embodiment, the online meeting control device may be configured to transmit summary information about the determined route to an online meeting platform server so that the information is shared with other users participating in the online meeting.

In an embodiment, the navigation device may be configured to determine, when information about a start time of the online meeting exists, a route passing through a place where parking or stopping is possible or a road that supports a certain level or higher of semi-autonomous driving function at the start time.

In an embodiment, the operating status of the vehicle may include at least one of information about whether the vehicle is parked or stopped or information about whether a driver assistance function is activated or intervenes.

According to various embodiments of the present disclosure described above, it is possible to provide various functions in consideration of the in-vehicle environment when executing an online meeting service in a vehicle.

In particular, according to embodiments of the present disclosure, since the driver's participation status is configured or information related to other users is provided in consideration of the operating status of the vehicle or the situation of the driver when the driver participates in the online meeting service in the vehicle, the meeting can proceed smoothly.

Advantageous effects obtainable from the present disclosure are not limited to the above-mentioned effects. Other effects that are not mentioned herein should be more clearly understood from the following descriptions by those having ordinary skill in the art to which the present disclosure pertains.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 illustrates an example of the configuration of an online meeting service providing system according to an embodiment.

FIG. 2 illustrates an example of a vehicle configuration providing an online meeting service according to an embodiment.

FIG. 3 is a flowchart illustrating an example of a process of providing an online meeting service in a vehicle according to an embodiment.

FIG. 4 illustrates an example of a change in participation status of a vehicle participant according to an embodiment.

FIG. 5 illustrates a display state showing an example of providing an online meeting service including a vehicle participant according to an embodiment.

FIG. 6 illustrates a display state showing another example of providing an online meeting service including a vehicle participant according to an embodiment.

FIG. 7 illustrates a display state showing an example of providing route information of a vehicle participant in an online meeting service including the vehicle participant according to an embodiment.

FIG. 8 illustrates a display state showing another example of providing route information of a vehicle participant in an online meeting service including the vehicle participant according to an embodiment.

FIG. 9 illustrates a display state showing an example of providing situation information of a vehicle participant in an online meeting service including the vehicle participant according to an embodiment.

FIG. 10 illustrates a display state showing another example of providing situation information of a vehicle participant in an online meeting service including the vehicle participant according to an embodiment.

FIG. 11 illustrates a display state showing another example of providing situation information of a vehicle participant in an online meeting service including the vehicle participant according to an embodiment.

FIG. 12 illustrates a display state showing another example of providing situation information of a vehicle participant in an online meeting service including the vehicle participant according to an embodiment.

It should be understood that the accompanying drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Hereinafter, embodiments of the present disclosure are described in detail with reference to the accompanying drawings. In the following description and the accompanying drawings, the same or similar elements are given the same or similar reference numerals regardless of figure numbers, and duplicate descriptions thereof have been omitted. The terms “module” and “unit” used for the elements in the following description are given or interchangeably used in consideration of only the ease of explanation, and do not have distinct meanings or roles by themselves. In addition, in relation to describing the embodiments disclosed in the present specification, where the detailed description of the relevant known technology was determined to unnecessarily obscure the gist of the present disclosure, the detailed description thereof has been omitted. In addition, it should be appreciated that the accompanying drawings are provided merely to enhance understanding of the embodiments set forth herein. The technical idea of the present disclosure is not limited to the accompanying drawings and includes all modifications, equivalents, or alternatives falling within the spirit and scope of the present disclosure.

Terms including an ordinal number such as “a first” or “a second” may be used to describe various elements, but the elements are not limited to the terms. Such terms are used merely for the purpose of distinguishing one element from other elements.

In the case where an element is referred to as being “connected” or “coupled” to any other elements, it should be understood that not only the element may be directly connected or coupled to the other elements, but also another element may exist therebetween. On the other hand, in the case where an element is referred to as being “directly connected” or “directly coupled” to any other element, it should be understood that no other element exists therebetween.

When a component, device, module, element, or the like of the present disclosure is described as having a purpose or performing an operation, function, or the like, the component, device, or element should be considered herein as being “configured to” meet that purpose or perform that operation or function.

A singular expressions may include plural expressions unless the context clearly indicates otherwise.

As used herein, the expressions such as “include,” “comprise,” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

A unit or a control unit included in names such as a motor control unit (MCU) or a hybrid control unit (HCU) is merely a term widely used for naming a controller configured to control a specific function of a vehicle, but does not mean a generic function unit. For example, in order to control a function that a control unit is responsible for, each control unit may include a communication device configured to communicate with a sensor or another control unit, a memory configured to store an operation system, a logic command, or input/output information, and at least one processor configured to perform determination, calculation, decision or the like that are required for responsible function controlling.

Embodiments of the present disclosure provide an apparatus and a method for providing an online meeting service that provides various functions considering the in-vehicle environment. Here, considering the in-vehicle environment may indicate that, when a driver riding in a vehicle participates in an online meeting, the possible interaction level of the driver is derived in consideration of safety by determining the driving situation of the vehicle and the situation of the driver overall. In various embodiments, the functions considering the in-vehicle environment may indicate functions of adjusting the participation status of the online meeting or restricting at least some functions according to the derived possible interaction level, and informing other participants of information related to the in-vehicle environment. Through this, other participants may understand the driver's situation, thereby facilitating smooth progress of the meeting.

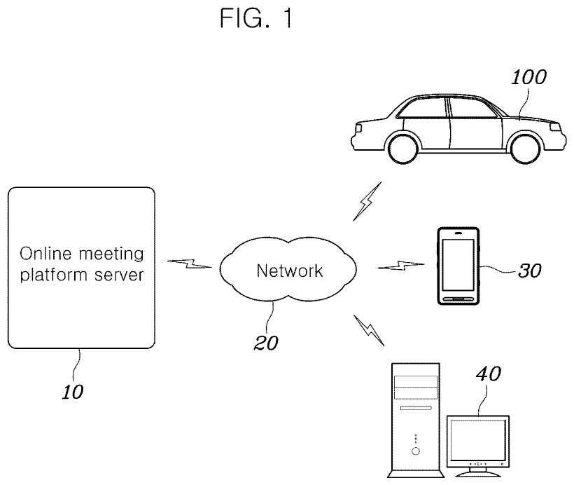

FIG. 1 illustrates an example of the configuration of an online meeting service providing system according to an embodiment.

Referring to FIG. 1, an online meeting service providing system according to an embodiment may include an online meeting platform server 10 and a plurality of client devices 30, 40, and 100 connected to the online meeting platform server 10 through a network 20.

The network 20 may include any wired and/or wireless network as long as the network 20 is able to support data exchange between the online meeting platform server 10 and the client devices 30, 40, and 100. The network 20 is not limited to a specific connection protocol.

The client devices according to the embodiment may include a mobile terminal 30 or a fixed terminal 40, similarly to a general online meeting service, and a terminal provided in a vehicle 100. The client devices 30, 40, and 100 may run a dedicated application to connect to the online meeting platform server 10. However, this is merely illustrative and the present disclosure is not limited thereto. For example, the connection may be established through a web browser, which is widely used these days.

The online meeting platform server 10 may perform multiple-account management functions, online-meeting room management functions, etc. The account management functions may denote management functions for account creation, information update, deletion, etc. In addition, the online-meeting room management functions may denote functions for creating a meeting room, inviting participants, and exchanging data (video, voice, or other media) between participants when one or more participants enter a meeting room. In particular, according to an embodiment, the online meeting platform server 10 may, when the connected client device is a terminal of the vehicle 100 or when an account of a driver riding in the vehicle 100 is accessed, provide specialized functions, described in more detail below, for the meeting room in which the user is a participant. Hereinafter, for convenience of explanation, a user who participates in the online meeting through a terminal of the vehicle 100 or participates in the online meeting through an account configured as a driver riding in the vehicle 100 are sometimes referred to herein as a “vehicle participant”.

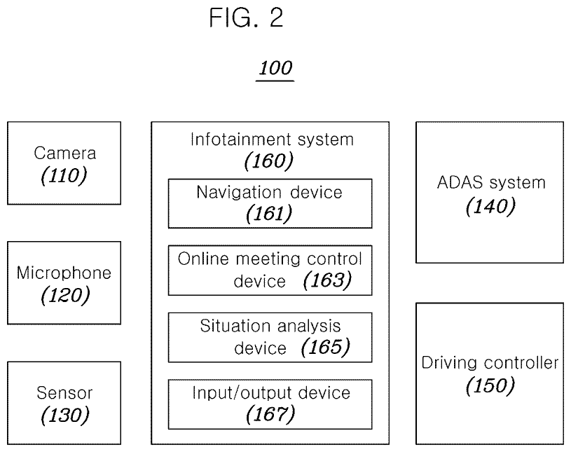

FIG. 2 illustrates an example of a vehicle configuration providing an online meeting service according to an embodiment.

Referring to FIG. 2, a vehicle 100 according to an embodiment may include a camera 110, a microphone 120, a sensor 130, an advanced driver assistance system (ADAS) 140, a driving controller 150, and an infotainment system 160.

FIG. 2 shows the primary configurations related to embodiments of the present disclosure, and it should be apparent that the actual vehicle may include more or fewer components, in various embodiments. The respective components, according to embodiments, are described in more detail below.

The camera 110 may be provided to capture images of the surroundings of the vehicle. In an embodiment, the camera 10 is disposed in a location (e.g., cluster, top of windshield, center fascia, or the like) suitable for capturing the driver in the field of view indoors in order to share the image of the vehicle participant who participates in an online meeting in the meeting room. In this case, the image of the driver captured through the camera 110 may be used as a basis for determining whether or not the driver is looking forward.

The microphone 120 may be disposed at a suitable location to acquire the driver's voice.

The sensor 130 may include various sensors for detecting the status of the vehicle, such as a wheel speed sensor, a steering angle sensor, a pedal sensor, and the like. However, the present disclosure is not limited thereto.

The advanced driver assistance system 140 may provide information on whether various driver assistance functions are activated or intervened to the infotainment system 160. Here, the driver assistance functions may include functions of enhancing the driver's freedom, such as a Smart Cruise Control (SCC) or autonomous driving, as well as functions that intervene in relatively dangerous situations, such as an Anti-lock Brake System (ABS), a Traction Control System (TCS), and Electronic Stability Control (ESC).

The driving controller 150 may include controllers that control components essential for driving the vehicle, such as a braking system, a steering system, and a driving system. In general, the advanced driver assistance system 140 may intervene in driving by transmitting a control command to the driving controller 150.

The infotainment system 160 may provide both an information providing function and an entertainment function. The infotainment system 160 may also be referred to as an Audio/Video/Navigation/Telematics (AVNT) terminal or head unit. The infotainment system 160 may include a navigation device 161 that provides a navigation function for route guidance in relation to the embodiment, an online meeting control device 163 that provides a function related to an online meeting service, a situation analysis device 165 that analyzes the driver and driving situations, and an input/output device 167 that provides various input means and output means.

The navigation device 161 may perform a function of guiding the driver a route determined according to predetermined criteria from the current location to the destination through the input/output device 167. In particular, the navigation device 161 according to the embodiment may collect real-time road information (traffic congestion, accident locations, etc.) through a connected car service or the like, and may also obtain information about dangerous or caution sections. In addition, the navigation device 161 may provide the entire route summary function described later.

The online meeting control device 163 may access the online meeting platform server 10 and may provide an online meeting service. For example, the online meeting control device 163 may execute an online meeting application or access the online meeting platform server 10 through a web browser, and may provide the driver with a user interface according to the execution of the online meeting service through the input/output device 167. When executing the online meeting service, the online meeting control device 163 may transmit images captured through the camera 110 and sound acquired through the microphone 120 to the online meeting platform server 10, and may receive voices and images of other users and output them through the input/output device 167. In addition, the online meeting control device 163 may obtain route information from the navigation device 161 and may transmit the route information to the online meeting platform server 10 so that the route information may be shared with other users. In addition, the online meeting control device 163 may configure the status of the vehicle participant in the meeting room or restrict at least some functions, such as video/audio input and output, depending on the possible interaction level analyzed by the situation analysis device 165.

The situation analysis device 165 may obtain information for analyzing the possible interaction level of the driver from various components of the vehicle 100 and determine the possible interaction level, based on the information. For example, the situation analysis device 165 may determine, through the camera 110, whether the driver is looking ahead or operating other functions, and may obtain information about the current location or the caution section ahead from the navigation device 161. In addition, the situation analysis device 165 may obtain information about whether auxiliary functions are activated or intervene from the sensor 130 or the advanced driver assistance system 140. Information about the possible interaction level determined based on the same may be provided to the online meeting control device 163.

The input/output device 167 may include an input means for receiving commands from the driver or passenger, and an output means for outputting visual or auditory information. Examples of the input means may include key buttons, dials, touch pads, etc., and may be configured to recognize voice commands based on sound input through the microphone 120. Examples of the output means may include a speaker for outputting recognizable auditory information and a display for outputting visually recognizable information. However, these are merely illustrative, and the input and output means are not limited thereto. For example, the input/output device 167 may include a touchscreen that functions as both an input means and an output means.

In implementation, the infotainment system 160 may be configured to include hardware such as a display device corresponding to the input/output device 167, a memory that stores instructions corresponding to functions performed by the remaining devices 161, 163, and 165 or applications configured as the same, and a processor that processes the instructions and makes a decision. In addition, the infotainment system 160 may further include a communication device for exchanging data with other components in the vehicle 100 through a vehicle communication protocol, and a communication device for exchanging data with the online meeting service platform server 10 through a wireless communication protocol.

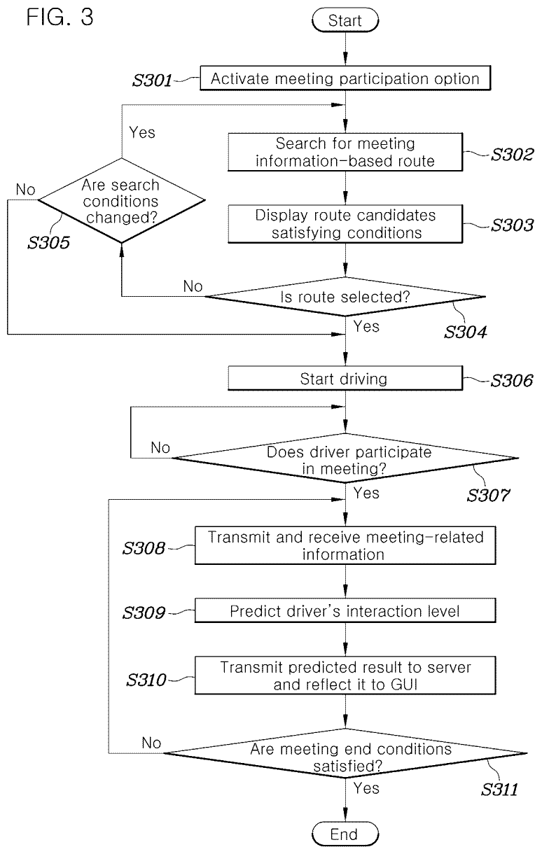

FIG. 3 is a flowchart illustrating an example of a process of providing an online meeting service in a vehicle according to an embodiment.

Referring to FIG. 3, in a step or operation S301, a meeting participation option may be activated by a driver. Activation of the meeting participation option may be configured by manipulating a menu provided from the infotainment system 160 in the vehicle 100. However, this is merely illustrative, and the activation is not limited thereto. For example, activation of the meeting participation option may be configured in the infotainment system 160 if the meeting attendance schedule and the driving schedule overlap. Here, the meeting participation option may indicate a function of searching for a route that allows the driver to actively participate in the online meeting by passing through, during the meeting time, a place where the driver is able to stop/park (e.g., a gas station, charging station, parking lot, rest area, etc.) or a dedicated car road or highway that allows activation of a high level (e.g., level 3 or higher) of autonomous/semi-autonomous driving function.

If the meeting participation option is activated, the infotainment system 160 may search for a route, based on meeting information in a step or operation S302. Here, the meeting information may include information about the start time, end time, and the like of the online meeting.

If route candidates that satisfy the conditions, i.e., route candidates that allow for stopping/parking or autonomous/semi-autonomous driving during the scheduled online meeting time, are searched for through the navigation device 161, the route candidates may be output through the input/output device 167 in a step or operation S303.

If there is no suitable route (“No” in a step or operation S304), the driver may change the search conditions (e.g., change the start time or the scheduled participation time) (“Yes” in a step or operation S305) to perform route re-search in the step or operation S302.

On the other hand, if one of the route candidates is selected (“Yes” in the step or operation S304), driving may begin with the selected route guidance in a step or operation S306. If no suitable route is selected and if there is no change in the search conditions (“No” in the step or operation S305), the general optimal route may be recommended or vehicle driving may begin without route guidance in a step or operation S306.

Participation in the online meeting may be performed according to command input by the driver or according to the control of the online meeting control device 163 when the scheduled online meeting time arrives.

In the case of participating in the online meeting (“Yes” in a step or operation S307), the online meeting control device 163 may control the input/output device 167 to provide a graphic user interface corresponding to the online meeting service, and may transmit and receive meeting-related information to and from the online meeting platform server 10 in a step or operation S308. Here, the meeting-related information may include at least one of the driver's video or voice, the video and voice of other participants, and driving route information of the vehicle 100.

In addition, according to the meeting participation, the situation analysis device 165 may determine (or predict) the driver's interaction level in a step or operation S309.

If the driver's interaction level is determined, the online meeting control device 163 may adjust the user interface output through the input/output device 167 to correspond to the determined interaction level, such as changing the participation status of the vehicle participant or restricting some functions, and may also transmit the determined information to the online meeting platform server 10 in a step or operation S310. Accordingly, the online meeting platform server 10 may reflect information about the driver's interaction level to the user interfaces of other users participating in the meeting room.

The processes of the above-described steps or operations S308-S310 may be repeatedly performed until the meeting ends (“Yes”in a step or operation S311).

Specific adjustment of the user interface, such as changing the participation status of the vehicle participant and restricting functions depending on the above-described driver's interaction level, according to embodiments, are described in more detail below.

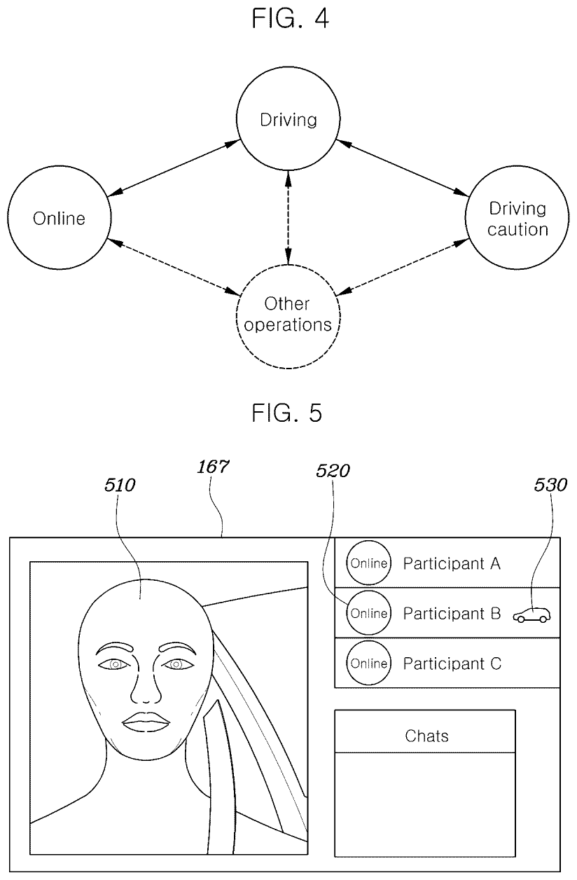

FIG. 4 illustrates an example of a change in participation status of a vehicle participant according to an embodiment.

Referring to FIG. 4, the participation status according to the driver's interaction level may include four states such as an online state, a driving state, a driving caution state, and an other-operation state.

The online state may correspond to the state where the vehicle is parked/stopped or where an autonomous/semi-autonomous driving requiring a lower level of driving intervention is in progress, and all functions may be supported without limitations in this state during participating in the online meeting.

The driving state may correspond to the state where the vehicle is being driven without activation of the autonomous/semi-autonomous driving function. In the driving state, a function of providing video of other participants to the driver may be limited, and only voice conferences may be supported.

The other-operation state may correspond to the state where an operation other than the general online meeting service is in progress or where the driver's seat is empty, and the camera 110 and microphone 120 may be turned off. The other-operation state may be activated when a manipulation of the input/output device 167 is detected in the online state or when the infotainment system 160 detects the driver's gaze diversion from the video captured by the camera 110. This state may be activated when a non-driving-related manipulation of the input/output device 167 is detected in the driving state. However, this is merely an example and the state is not limited thereto.

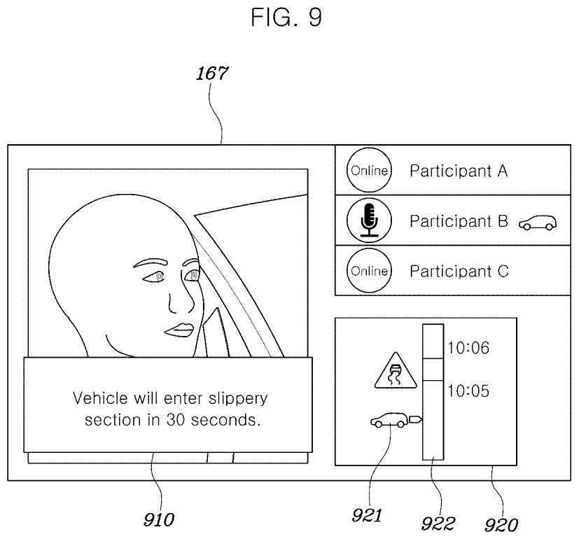

The driving caution state may correspond to the state where the driving must not be disturbed by the general online meeting service or the offline state, and the camera 110 and microphone 120 may be turned off. The driving caution state may be activated when entering a caution section (e.g., an accident-prone section, a construction section, a sharp curve section, an accident site, etc.) acquired through the navigation device 161 or when vehicle posture correction functions (e.g., ABS, TCS, ESC, etc.) are conducted. In an example, the driving caution state according to the embodiment may be activated through a warning function. Here, the warning function may indicate a function of informing, if there is a caution section ahead obtained through the navigation device 161, the vehicle participant and other participants of the remaining time or distance for the vehicle 100 to enter the section through the user interface. This warning function, according to an embodiment, is described in more detail below with reference to FIGS. 9-12 .

FIG. 5 illustrates a display state showing an example of providing an online meeting service including a vehicle participant according to an embodiment.

The display states in FIG. 5 and subsequent drawings shows the user interface displayed when participating in a meeting room of an online meeting service, and it is assumed that there are three participants in the meeting room, such as participant A, participant B, and participant C, and that participant B is the driver of the vehicle 100, i.e., the vehicle participant, according to an embodiment.

Referring to FIG. 5, an example of a user interface is illustrated, that is provided when entering an online meeting room as the online meeting service function is executed. This user interface (e.g., user interface (UX) or graphical user interface (GUI)) may be displayed through the input/output device 167 of the infotainment system 160, for example, a touch screen, for the vehicle participant.

The user interface may have the largest area occupied by the video of the participant currently speaking, among the participants in the meeting room, i.e., the speaker video 510, and may also include a participant list and a chat window. However, this interface configuration is merely illustrative and the user interface is not limited thereto. If the speaker is not participant B, the corresponding participant's video may be displayed as the speaker video 510.

The participant list may display status information of each user. For example, the item corresponding to user B, who is a vehicle participant, may display a vehicle icon 530 indicating that the user is a vehicle participant, and participation status 520 corresponding to the driver's possible interaction level determined by the situation analysis device 165. In an example, as shown in FIG. 5, if the driver is able to look at the camera 110 in a stopped state, the participation status 520 may be configured as online.

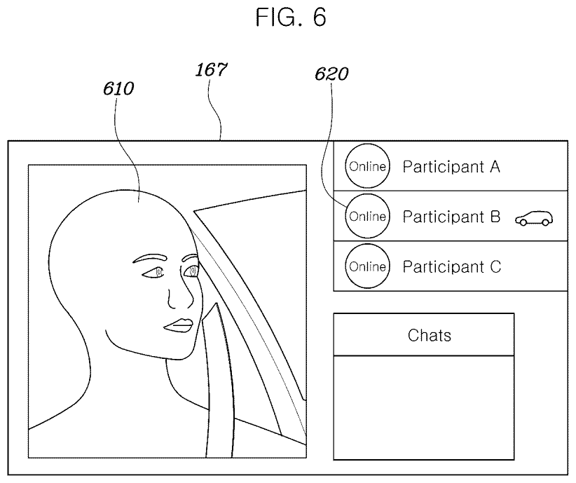

FIG. 6 illustrates a display state showing another example of providing an online meeting service including a vehicle participant according to an embodiment.

In FIG. 6, it is assumed that the driver is driving while looking ahead, as shown in the speaker video 610. In this case, the situation analysis device 165 may determine the possible interaction level to be a driving state, and the online meeting control device 163 may configure the participation status 620 as the driving state according thereto. According to the configuration, if the driver's video display function is restricted in the driving state, the speaker video 610 may not be displayed in the user interface provided on the display 167 of the vehicle 100. However, the speaker video may be continuously provided to the user interface of other participants A and C, excluding the vehicle participant.

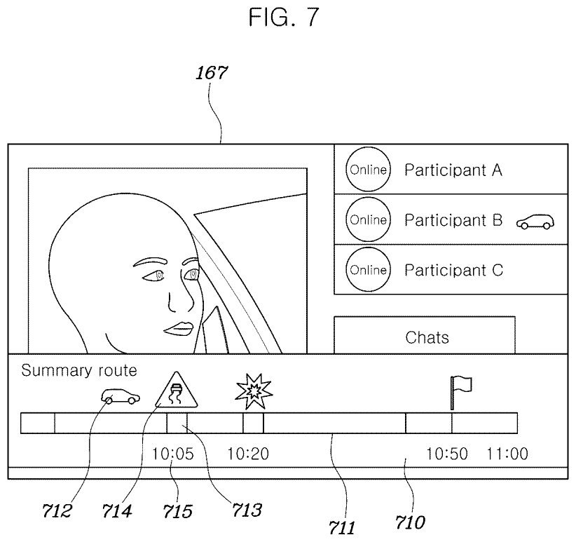

FIG. 7 illustrates a display state showing an example of providing route information of a vehicle participant in an online meeting service including the vehicle participant according to an embodiment.

If a predetermined command input (e.g., selection of the vehicle icon 530 in FIG. 5) is detected while providing the user interface according to the participation in the meeting room, as illustrated in FIG. 7, summary information 710 of the route on which the vehicle participant's vehicle 100 is driving may be provided. This route summary information 710 may be shared with the respective participants by providing the route information to the online meeting platform server 10 in step or operation S308 described above with reference to FIG. 3.

The route summary information 710 may include a progress bar 711 corresponding to the entire route and divided according to the caution section or congestion, an icon 712 indicating the current location of the vehicle 100 on the progress bar 711, an icon 714 indicating the type of caution section 713, information 715 about the expected arrival time to the caution section 713, and the like. However, these are merely illustrative and the route summary information is not limited thereto. Through this route summary information 710, the respective participants may predict when the vehicle participant actively participates in the meeting or is restricted from participating in the meeting, thereby facilitating smooth progress of the meeting.

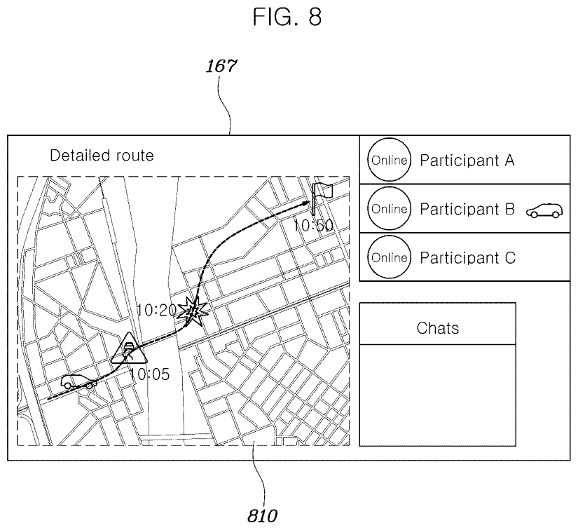

FIG. 8 illustrates a display state showing another example of providing route information of a vehicle participant in an online meeting service including the vehicle participant according to an embodiment.

Unlike that in FIG. 7, the route summary information 810 in FIG. 8 may be provided to be overlaid on the map.

According to an embodiment, the route summary information may be provided through either one of the forms shown in FIG. 7 and FIG. 8, or may switch between them.

FIG. 9 illustrates a display state showing an example of providing situation information of a vehicle participant in an online meeting service including the vehicle participant according to an embodiment.

Referring to FIG. 9, if there is a caution section ahead on the route of the vehicle 100 being driven by the vehicle participant during the online meeting, progress information 920 may be provided along with an event notification message 910 to the user interface. The progress information 920 may intuitively inform of the remaining distance or time to the caution section by displaying the location 921 of the vehicle 100 on the progress bar 922. Through this, the vehicle participant who is currently speaking may finish speaking or ask for understanding from other participants before entering the caution section. The progress information 920 may be output when a predetermined condition is satisfied, for example, when the remaining distance or time until entering the caution section reaches a predetermined value.

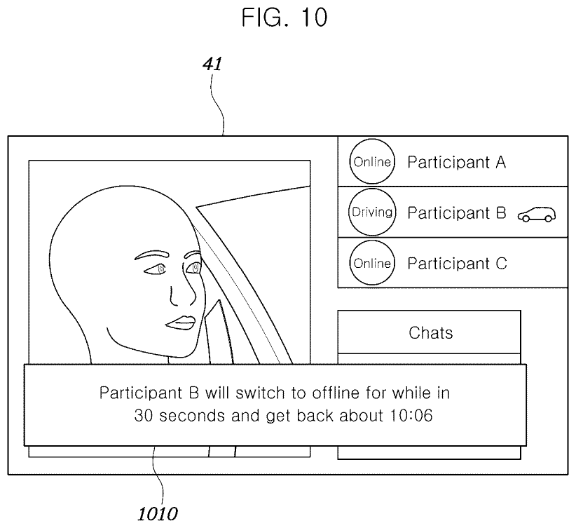

FIG. 10 illustrates a display state showing another example of providing situation information of a vehicle participant in an online meeting service including the vehicle participant according to an embodiment.

While the user interface shown in FIG. 9 is being displayed on the vehicle display 167 of the vehicle participant, a user interface shown in FIG. 10 may be provided to displays 41 of other participants. Referring to FIG. 10, the remaining participants may be aware, through an event notification message 1010, that the vehicle participant will soon switch to an offline state and when the vehicle participant will get back to the meeting.

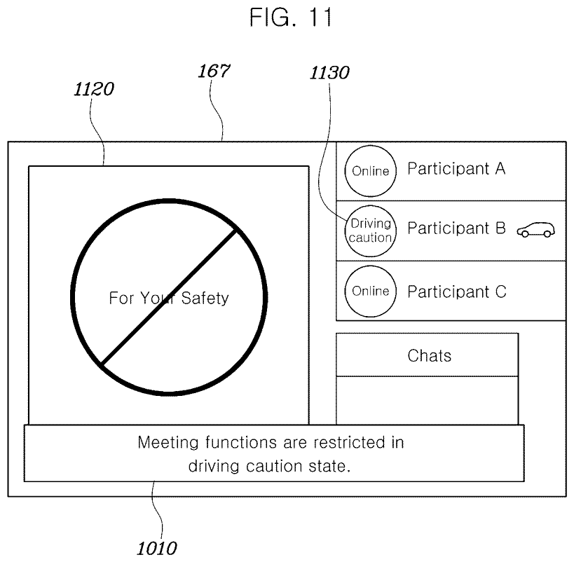

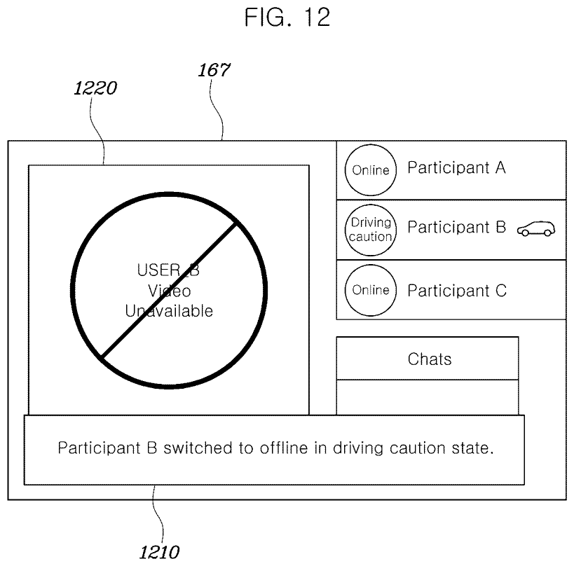

FIG. 11 illustrates a display state showing another example of providing situation information of a vehicle participant in an online meeting service including the vehicle participant according to an embodiment.

If the vehicle 100 enters a caution section after the screen shown in FIG. 9 is provided, as shown in FIG. 11, the speaker screen 1120 may be deactivated for the driver's safety along with the output of an event notification message 1110, and the participation status 1130 of the item corresponding to the vehicle participant may be changed to the driving caution state in the participant list.

FIG. 12 illustrates a display state showing another example of providing situation information of a vehicle participant in an online meeting service including the vehicle participant according to an embodiment.

While the user interface shown in FIG. 11 is being displayed on the vehicle display 167 of the vehicle participant, a user interface shown in FIG. 12 may be provided to the displays 41 of other participants. Referring to FIG. 12, the reason for switching to the offline state of the vehicle participant may be conveyed through an event notification message 1210, and the video 1220 of the vehicle participant may be deactivated.

Notification of switching to the offline state of the vehicle participant may be provided through the user interface shown in FIGS. 11 and 12 after notice as shown in FIGS. 9 and 10, or may also be provided in the case of switching to the driving caution state due to an unexpected event (e.g., intervention of a posture control function) that was not predicted from navigation information.

The present disclosure as described above may be implemented as codes in a non-transitory computer-readable medium in which a program is recorded in the form of computer-readable instructions, for example. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. The non-transitory computer-readable medium may store computer-readable instruction that, when executed by at least one processor, may cause the at least one processor to perform steps or operations as described above. Therefore, the above detailed description should not be construed in a limitative sense, but should be considered in an illustrative sense in all aspects. The scope of the present disclosure should not be determined by reasonable interpretation of the appended claims, and all changes and modifications within the equivalent scope of the present disclosure fall within the scope of the present disclosure.

What is claimed is:

1. A method of providing an online meeting service considering an in-vehicle environment, the method comprising:
accessing an online meeting through a terminal of a vehicle;
determining a possible interaction level of a driver of the vehicle during the online meeting, based on operating status of the vehicle, while participating in the online meeting; and
configuring participation status in the online meeting depending on the possible interaction level.

2. The method of claim 1, wherein the method further comprises transmitting information about the determined possible interaction level to an online meeting platform server so that the information is shared with other users participating in the online meeting.

3. The method of claim 1, wherein the participation status includes a plurality of states having different possible interaction levels and proposing functions.

4. The method of claim 1, wherein the method further comprises restricting at least one of functions of transmitting or receiving at least one of video or audio depending on the determined possible interaction level.

5. The method of claim 1, further comprising:
determining a route to a destination; and
determining whether or not a driving caution section exists on the route,
wherein configuring the participation status includes, in response to determine that the driving caution section exists and as the vehicle enters the driving caution section, adjusting the participation status to a state corresponding to an entry into the driving caution section.

6. The method of claim 5, wherein the method further comprises, in response to determine that the driving caution section exists and a predetermined condition is satisfied before the vehicle enters the driving caution section, outputting progress information including at least one of a remaining time or a distance until the vehicle enters the driving caution section.

7. The method of claim 5, wherein the method further comprises transmitting summary information about the route to an online meeting platform server so that the summary information is shared with other users participating in the online meeting.

8. The method of claim 5, wherein determining the route includes, upon determining that information about a start time of the online meeting exists, determining a route passing through a place where parking or stopping is possible or a road that supports a certain level or higher of semi-autonomous driving function at the start time.

9. The method of claim 1, wherein the operating status of the vehicle includes at least one of information about whether the vehicle is parked or stopped or information about whether a driver assistance function is activated or intervenes.

10. A non-transitory computer-readable medium storing computer-readable instructions that, when executed by at least one processor, cause the at least one processor to:
access an online meeting through a terminal of a vehicle;
determine a possible interaction level of a driver of the vehicle during the online meeting, based on operating status of the vehicle, while participating in the online meeting; and
configure participation status in the online meeting depending on the possible interaction level.

11. An apparatus for providing an online meeting service for a vehicle, the apparatus comprising:
an input/output device;
an online meeting control device configured to provide a user interface through the input/output device when accessing an online meeting; and
a situation analysis device configured to determine a possible interaction level of a driver during the online meeting, based on operating status of the vehicle, while participating in the online meeting,
wherein the online meeting control device is configured to configure participation status in the online meeting depending on the possible interaction level.

12. The apparatus of claim 11, wherein the online meeting control device is configured to transmit information about the determined possible interaction level to an online meeting platform server so that the information is shared with other users participating in the online meeting.

13. The apparatus of claim 11, wherein the participation status includes a plurality of states having different possible interaction levels and proposing functions.

14. The apparatus of claim 11, wherein the online meeting control device is configured to restrict at least one of functions of transmitting or receiving at least one of video or audio depending on the possible interaction level.

15. The apparatus of claim 11, further comprising a navigation device configured to:
determine a route to a destination; and
determine whether or not a driving caution section exists on the determined route, and
wherein the online meeting control device is configured to, when the driving caution section exists and as the vehicle enters the driving caution section, adjust the participation status to a state corresponding to an entry into the driving caution section.

16. The apparatus of claim 15, wherein the online meeting control device is configured to output, when the driving caution section exists and when a predetermined condition is satisfied before the vehicle enters the driving caution section, progress information including at least one of a remaining time or a distance until the vehicle enters the driving caution section.

17. The apparatus according to claim 15, wherein the online meeting control device is configured to transmit summary information about the determined route to an online meeting platform server so that the summary information is shared with other users participating in the online meeting.

18. The apparatus according to claim 15, wherein the navigation device is configured to, when information about a start time of the online meeting exists, determine a route passing through a place where parking or stopping is possible or a road that supports a certain level or higher of semi-autonomous driving function at the start time.

19. The apparatus according to claim 11, wherein the operating status of the vehicle includes at least one of information about whether the vehicle is parked or stopped or information about whether a driver assistance function is activated or intervenes.
